(19) United States
(12) Patent Application Publication
(10) Pub. No.: US 2009/0205341 A1
(43) Pub. Date: Aug. 20, 2009

(54) GAS TURBINE ENGINE WITH TWIN TOWERSHAFT ACCESSORY GEARBOX

(76) Inventor: Marc J. Muldoon, Marlborough, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/033,902

(22) Filed: Feb. 20, 2008

(51) Int. Cl. F02C 3/10

(52) U.S. Cl. 60/792; 60/224

(57) ABSTRACT

A gas turbine engine includes a high towershaft driven by a high pressure spool and a low towershaft driven by a low pressure spool.

### STATEMENT REGARDING FEDERALLY SPONSORED RESEARCH OR DEVELOPMENT

This invention was made with government support under Contract No.: 07-01-PRK, proposal call 01, awarded by the United States Air Force. The government therefore has certain rights in this invention.

### BACKGROUND OF THE INVENTION

The present invention relates to a gas turbine engine, and more particularly to accessory gearboxes thereof.

Gas turbine engines often include a mechanically driven accessory gearbox to drive accessory systems such as, but not limited to, power generators, fuel pumps, oil pumps and hydraulic pumps. The power requirements for both military and commercial aircraft continue to increase demands on the accessory gearbox as the number of electrical systems within the aircraft continue to increase.

### SUMMARY OF THE INVENTION

A gas turbine engine according to an exemplary aspect of the present invention includes a high towershaft driven by a high pressure spool; and a low towershaft driven by a low pressure spool.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1A is a schematic sectional view through a gas turbine engine along the engine longitudinal axis illustrating an exemplary embodiment of a towershaft structure;

FIG. 1B is a forward axial view of the towershaft arrangement;

FIG. 1C is an expanded sectional view of the towershaft driven by the high pressure spool;

FIG. 1D is an expanded sectional view of the towershaft driven by the low pressure spool;

FIG. 2A is a schematic sectional view through a gas turbine engine along the engine longitudinal axis illustrating another exemplary embodiment of a towershaft structure; and

FIG. 2B is an expanded sectional view of the towershaft structure of FIG. 2A.

### DETAILED DESCRIPTION OF THE DISCLOSED EMBODIMENT

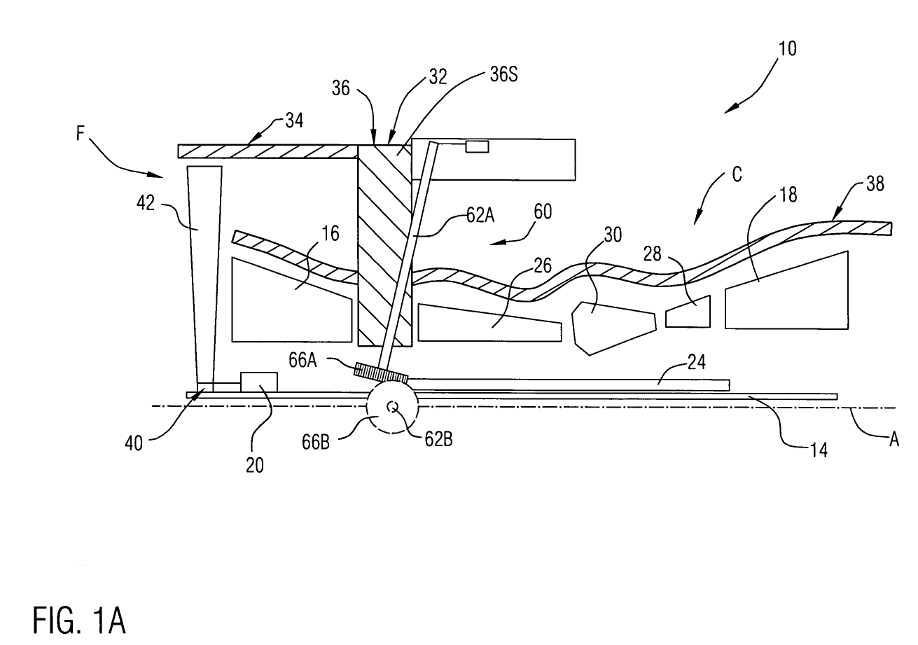

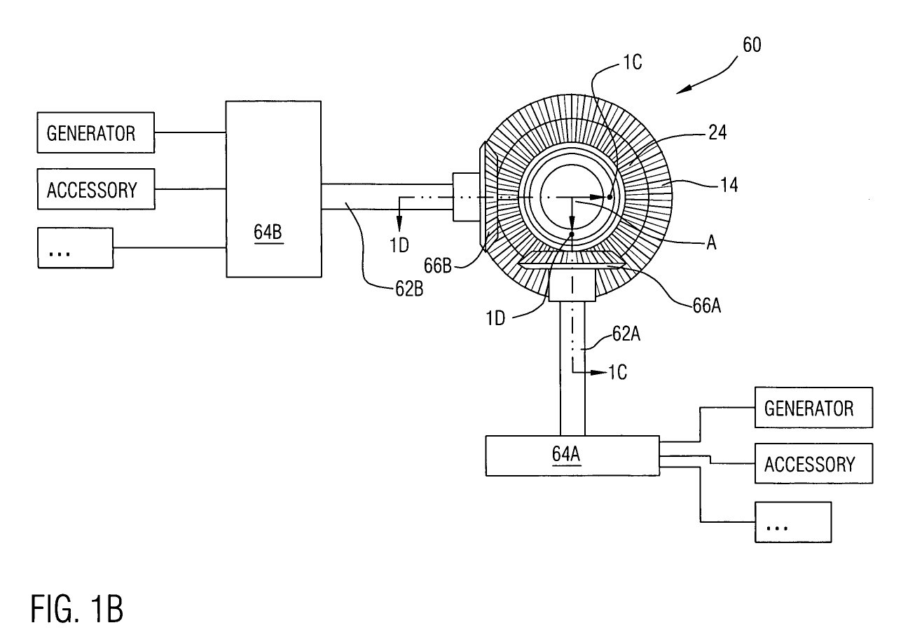

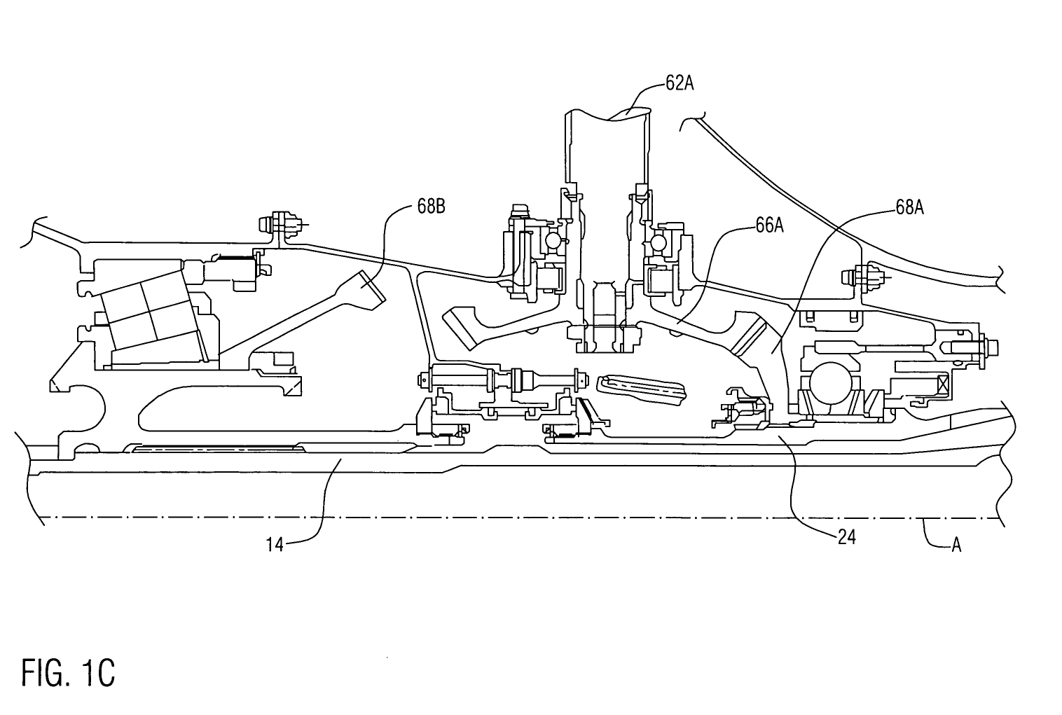

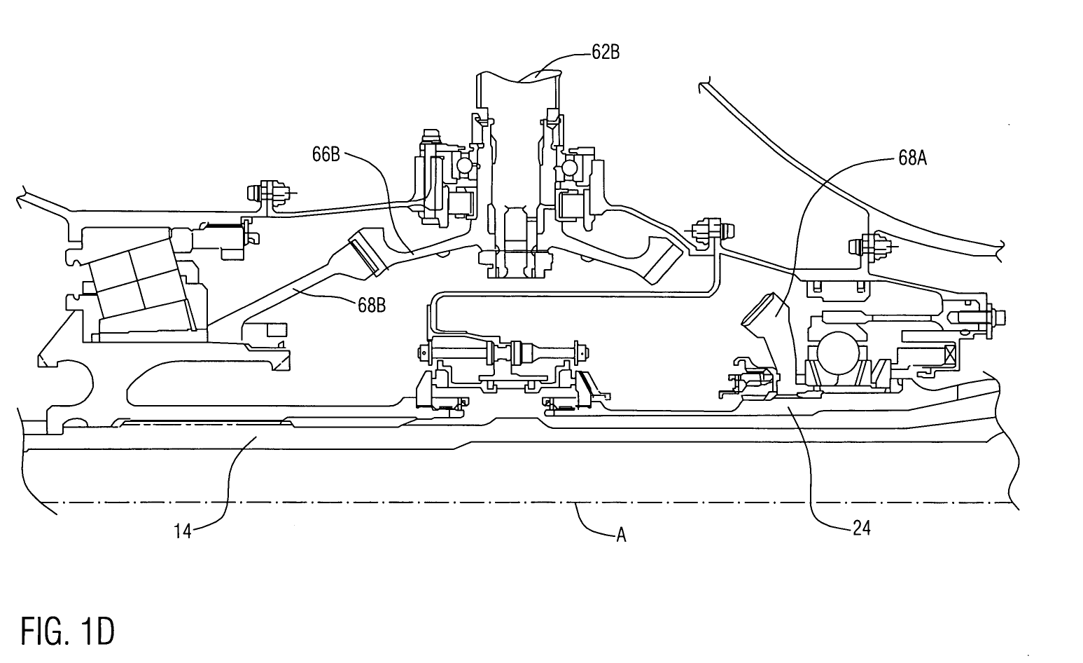

FIG. 1A illustrates a schematic sectional view of a gas turbofan engine 10 having a core engine C and a fan section F. The core engine C houses a low pressure spool 14 and a high pressure spool 24 which rotate about an engine axis of rotation A. The low pressure spool 14 includes a low pressure compressor 16 and a low pressure turbine 18. The high pressure spool 24 includes a high pressure compressor 26 and a high pressure turbine 28. A combustor 30 is arranged between the high pressure compressor 26 and the high pressure turbine 28. The low pressure spool 14 drives the fan section F either directly or through a gear system 20.

Airflow enters the fan section F where the airflow is split into a bypass airflow which bypasses the core engine C and a core airflow which enters the core engine C to power the low pressure compressor 16 and the high pressure compressor 26. Core airflow compressed by the low pressure compressor 16 and the high pressure compressor 26 is mixed with the fuel in the combustor 30, ignited and burned to generate combustor products. The resultant high pressure combustor products are expanded through the high pressure turbine 28 and low pressure turbine 18. The turbines 28, 18 are rotationally coupled to the respective compressors 26, 16 to drive the compressors 26, 16 in response to the expansion of the combustor product.

An engine static structure 32 includes a case structure often referred to as the engine backbone. The engine static structure 32 may include sub-structures, such as a fan case 34, an intermediate case (IMC) 36 and a core engine case structure 38.

The fan section F includes a fan rotor 40 with a plurality of circumferentially spaced radially outwardly extending fan blades 42 surrounded by the fan case 34. The fan case 34 is secured to the core engine case structure 38 at the IMC 36. The IMC 36 may include a multiple of circumferentially spaced, radially extending struts 36S which radially span the core engine C and the fan section F about the axis A.

Referring to FIG. 1B, an accessory gearbox drive system 60 includes at least one geartrain 64A, 64B (illustrated schematically). Each geartrain 64A, 64B is respectively driven by a high towershaft 62A and a low towershaft 62B which take power off of the respective high pressure spool 24 (FIG. 1C) and low pressure spool 14 (FIG. 1D). The high towershaft 62A and the low towershaft 62B are respectively driven through a respective bevel gear 66A, 66B in a direct drive approach with a gear pedestal 68A, 68B (FIGS. 1C and 1D) such that the towershafts 62A, 62B are in direct meshing engagement with the respective spools 24, 14.

The gear pedestal 68A, 68B are mounted to each of the respective high pressure spool 24 (FIG. 1C) and the low pressure spool 14 (FIG. 1D). The geartrains 64A, 64B may be utilized to drive various generator and accessory systems. The separate towershafts 62A, 62B facilitate operation of the geartrains 64A, 64B at equivalent or different speeds. The high towershaft 62A and the low towershaft 62B may be at least partially supported by the struts 36S within the IMC 36. In the exemplary embodiment, the towershafts 62A, 62B are oriented substantially transverse to axis of rotation A.

The high towershaft 62A and the low towershaft 62B together define a twin towershaft arrangement that facilitates usage of individually oriented towershafts that are each of a lesser size than a conventional single towershaft. This twin towershaft arrangement also facilitates increased power extraction, reduced impact on the engine airflow passages, and efficient engine performance. Since one of the generators (FIG. 1B) is driven by the low pressure spool 14, in one non-limiting embodiment, minimization of the operability impact on the high pressure spool 24 is facilitated. For example, conventional gas turbine engine systems may be subjected to aerodynamic effects that challenge stability when significant, e.g., 1 MW generator level power, is extracted from a conventional high rotor towershaft/gearbox system. However, in the twin towershaft arrangement, high extractions from the low pressure spool 14 has minimal effect on engine stability.

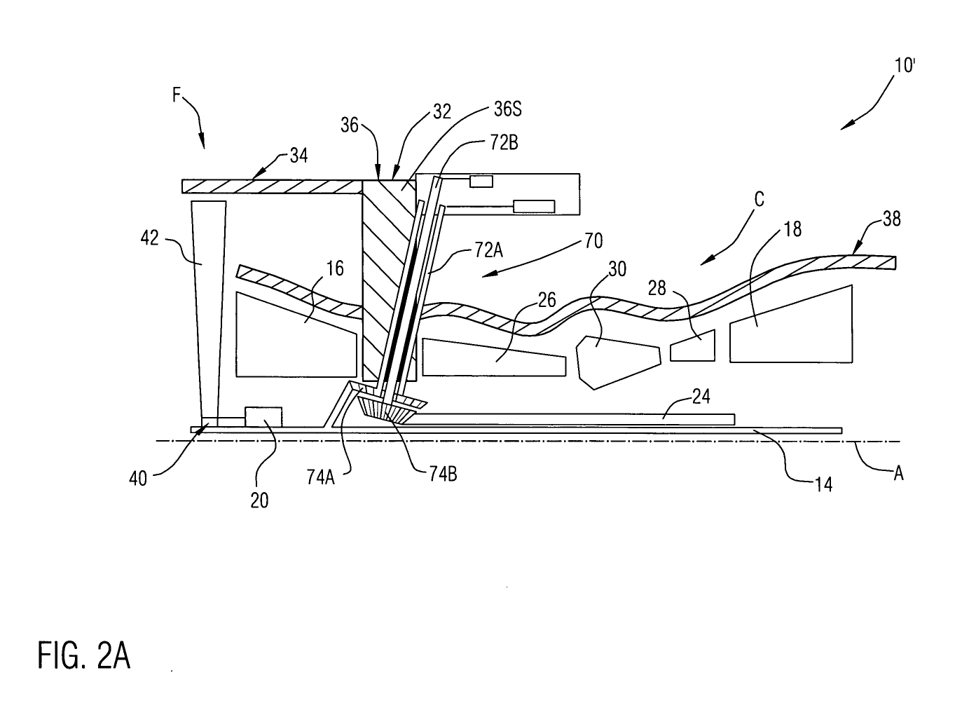

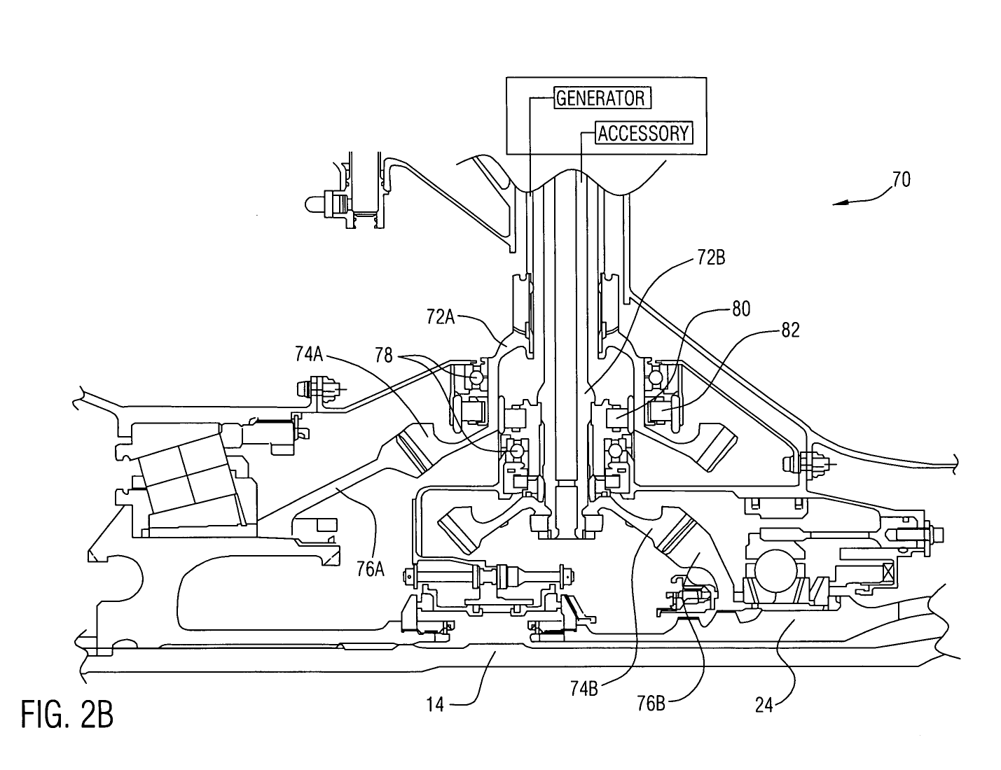

Referring to FIG. 2A, another non-limiting embodiment of an accessory gearbox drive system 70 utilizes a concentric towershaft arrangement in a gas turbine engine 10′. A low towershaft 72A and a high towershaft 72B are respectively driven through a bevel gear 74A, 74B in a direct drive approach with a gear pedestal 76A, 76B mounted to each of the respective low pressure spool 14 and high pressure spool 24 (also illustrated in FIG. 2B) such that the towershafts 72A, 72B are in direct meshing engagement with the respective spools 14, 24.

Referring to FIG. 2B, the low towershaft 72A is telescoped at least partially over the high towershaft 72B. A set of bearings 78 support each towershaft 72A, 72B. In one non-limiting embodiment, an intershaft roller bearing 80 radially supports the high towershaft 72B relative an inner diameter of the low towershaft 72A. A grounded roller bearing 82 may also be utilized to control a radial position of the low towershaft 72A relative to ground.

In one non-limiting embodiment, the high towershaft 72B may be connected to an accessory while the low towershaft 72A may be connected to a generator either directly or through a generator gear system. The low and high towershafts 72A, 72B together define a concentric towershaft arrangement in which each individual towershaft 72A, 72B includes a respective bevel gear 74A, 74B in a direct drive approach to facilitate, for example, a reduction of: external mount hardware; bearing compartment wall structure; fasteners; lubrication system components (plumbing, oil jets, etc); air seals; and oil seals. The low towershaft 72A and the high towershaft 72B facilitate usage of substantially coaxial towershafts that are each of a lesser size than a conventional single towershaft. The concentric approach also facilitates increased power extraction with reduced weight and complexity because both towershafts 72A, 72B may engage the gearbox through a single point of entry (FIG. 2A).

It should be understood that relative positional terms are with reference to the normal operational attitude of the vehicle and should not be considered otherwise limiting.

The foregoing description is exemplary rather than defined by the limitations within. Many modifications and variations of the present invention are possible in light of the above teachings. Exemplary embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A gas turbine engine comprising:
a high pressure spool which rotates about an axis of rotation;
a low pressure spool which rotates about said axis of rotation;
a high towershaft driven by said high pressure spool; and
a low towershaft driven by said low pressure spool.

2. The engine as recited in claim 1, wherein said high towershaft is oriented substantially transverse to said axis of rotation.

3. The engine as recited in claim 1, wherein said low towershaft is oriented substantially transverse to said axis of rotation.

4. The engine as recited in claim 1, wherein said high towershaft is oriented substantially transverse to said low towershaft.

5. The engine as recited in claim 1, wherein said high towershaft and said low towershaft are concentric.

6. The engine as recited in claim 1, wherein said high towershaft drives a geartrain within an accessory gearbox case.

7. The engine as recited in claim 1, wherein said high towershaft drives a geartrain within an accessory gearbox case and said low towershaft drives a generator.

8. The engine as recited in claim 1, wherein said high towershaft is in direct meshing engagement with said high pressure spool.

9. The engine as recited in claim 8, wherein said low towershaft is in direct meshing engagement with said low pressure spool.

10. A high-bypass gas turbine engine comprising:
a core engine defined about an axis, said core engine including a high pressure spool and a low pressure spool;
a fan driven by said core engine about said axis; and
a high towershaft driven by said high pressure spool; and
a low towershaft driven by said low pressure spool.

11. The engine as recited in claim 1, wherein said high towershaft is oriented substantially transverse to said axis.

12. The gas turbine engine as recited in claim 1, wherein said low towershaft is oriented substantially transverse to said axis.

13. The engine as recited in claim 10, wherein said high towershaft is substantially transverse to said low towershaft.

14. The engine as recited in claim 10, wherein said high towershaft and said low towershaft are concentric.

15. A method of driving accessory systems of a gas turbine engine comprising:
driving a high towershaft driven by a high pressure spool of a gas turbine engine, said high towershaft transverse to an axis of rotation; and
driving a low towershaft by a low pressure spool of the gas turbine engine, the low towershaft transverse to the axis of rotation.

16. A method as recited in claim 15, further comprising:
orienting the high towershaft substantially transverse to the low towershaft.

17. A method as recited in claim 15, further comprising:
orienting the high towershaft and the low towershaft in a concentric arrangement.

18. A method as recited in claim 15, further comprising:
driving a gear train within an accessory gearbox case through the high towershaft; and
driving a generator through the low towershaft.

19. A method as recited in claim 15, further comprising:
driving a gear train within an accessory gearbox case through the high towershaft.

20. A method as recited in claim 15, further comprising:
driving a generator through the low towershaft.
